(19) United States
(12) Patent Application Publication
(10) Pub. No.: US 2026/0169852 A1
(43) Pub. Date: Jun. 18, 2026

(54) Large-Scale Distributed Training Framework For Holistically Optimizing Training Goodput

(71) Applicant: Google LLC, Mountain View, CA (US)

(72) Inventors: Gerson Cheon Kroiz, Seattle, WA (US); Guillermo Nicolas Grande, Seattle, WA (US); Christopher John Pirillo, Carnation, WA (US); Daniel Crankshaw, San Francisco, CA (US); Parin B. Dalal, Palo Alto, CA (US); Allen Chenjim Wang, Cedar Park, TX (US)

(21) Appl. No.: 18/979,864

(22) Filed: Dec. 13, 2024

(51) Int. Cl. G06F 11/07; G06F 11/30

(52) U.S. Cl. CPC G06F 11/0793; G06F 11/0724; G06F 11/3006

(57) ABSTRACT

The present disclosure provides a customizable, large-scale distributed training framework for holistically optimizing training goodput. A holistic controller is responsible for monitoring and controlling state over an entire training cluster. This controller supports a suite of resiliency mechanisms for fault tolerance at various layers of the machine learning stack, intelligently selecting the best available fault tolerance mechanism to maximize goodput for a given machine learning workload.

### BACKGROUND

Training goodput is defined as the effective rate at which a model can be trained, accounting for the overall efficiency of the training process, considering factors like hardware utilization, network throughput, and the presence of errors or disruptions.

Running large workloads, especially in the generative AI space, easily scales up to thousands of hardware accelerators costing many millions of dollars. Customers paying for such premiums have no tolerance for performance inefficiencies or errors. Unfortunately, training at such large distributed scales runs into daily networking, hardware, and other miscellaneous issues, cutting overall training goodput. Introduction of a new graphics processing unit (GPU) generation can exacerbate the interruptions, such that training is interrupted every few hours for a time period following the implementation of the new GPU.

The industry standard is to reserve a portion of the training as “holdback” so that when the cluster runs into issues, the holdback capacity can replace existing hardware. In cloud settings, often the cloud provider will reserve some portion of available capacity as cloud-managed holdback for when customers report bugs and issues with their accelerators. Customers often may further define their own portion of holdback to more quickly swap out faulty hardware accelerators and can perform offline analysis on the fault hardware before flagging the hardware to the cloud provider. When combining both tiers of holdback, there are customers that end up losing over 30% of their total capacity to support efficient hot swapping-swapping faulty GPU hardware with fully functional GPU hardware while minimizing the time the training process is stopped.

Supporting enough holdback to make workloads resilient to faults is extremely expensive to customers as they sacrifice up to a third of their training capacity. Reserving holdback is also expensive in terms of training progress. Every fault that requires a hot swap has to stop training for up to 15 minutes in which training state is transferred to the new virtual machine. During this period all hosts also revert to the most recent checkpoint, losing any training progress not saved. Ultimately, reliance on holdback limits training goodput and in many cases strains customers from best using their accelerators.

### BRIEF SUMMARY

The present disclosure provides a customizable, large-scale distributed training framework for holistically optimizing training goodput. A holistic controller is responsible for monitoring and controlling state over an entire training cluster. This controller supports a suite of resiliency mechanisms for fault tolerance at various layers of the machine learning stack, intelligently selecting the best available fault tolerance mechanism to maximize goodput for a given machine learning workload.

One aspect of the disclosure provides a method for optimizing training goodput, the method comprising monitoring, by a supervisor node, heartbeat signals from all processing units participating in training; detecting, by the supervisor node, an anomaly based on the heartbeat signals; identifying, by the supervisor node, affected processing units affected by the anomaly; and determining, by the supervisor node, a response strategy for addressing the affected processing units at a worker level without pausing unaffected processing units. Detecting the anomaly may include, for example, detecting a missing heartbeat.

Another aspect of the disclosure provides a system for optimizing training, comprising a supervisor executing a plurality of independent processes, the independent processes including a sensor process, a controller process, and an actuator process. The supervisor is configured to monitor heartbeat signals from all processing units participating in training; detect an anomaly based on the heartbeat signals; identify affected processing units affected by the anomaly; and determine a response strategy for addressing the affected processing units at a worker level without pausing unaffected processing units.

For each of the method of system, the response strategy may include one of a processing unit reset, hot swapping of the affected processing units, or a dynamic data replication strategy. The processing unit reset may include issuing a callback from an optimization layer of a controller process executed by the supervisor node. The processing unit reset may include tainting a pod containing the affected processing units to prevent the pod from being scheduled for training; disabling any plugins of the affected processing units; creating a privileged pod on a target physical host; running a reset command for the affected processing units on the target physical host; re-enabling the plugins of the affected processing units; and untainting the pod, allowing it to be reintroduced into training. Hot swapping of the affected processing units may include registering all available hosts to the supervisor node; updating a status of each of the registered hosts; and preempting low priority workloads. Hot swapping the affected processing units may include swapping in a processing unit from cloud service managed holdback. The dynamic data replication strategy may include generating a physical mapping tracking all hosts and their respective processing units, and generating a virtual mapping tracking host and workload communication groups. The dynamic data replication strategy may include removing data replicas in response to a reduction in training capacity. The dynamic data replication strategy may include adding groups of data replicas in response to an increase in training capacity.

### BRIEF DESCRIPTION OF THE DRAWINGS

FIG. 1 is a block diagram of an example system according to aspects of the disclosure.

FIG. 2 is a block diagram of an example system executing a GPU reset according to aspects of the disclosure.

FIG. 3 is a block diagram of an example system performing host registration with the holistic controller according to aspects of the disclosure.

FIG. 4 is a block diagram of an example system initiating a workload after assigning states to pods according to aspects of the disclosure.

FIG. 5 is a block diagram of an example system receiving a heartbeat signal at the supervisor node according to aspects of the disclosure.

FIG. 6 illustrates an example scaling down according to aspects of the disclosure.

FIG. 7 illustrates an example arrangement of replicas according to aspects of the disclosure.

FIG. 8 illustrates an example of selectively pausing a subset of replicas corresponding to a failed replica according to aspects of the disclosure.

FIG. 9 illustrates an example of scaling up replicas according to aspects of the disclosure.

FIG. 10 is a block diagram of an example computing environment according to aspects of the disclosure.

FIG. 11 is a flow diagram illustrating an example method of holistic intelligent control according to aspects of the disclosure.

### DETAILED DESCRIPTION

The present disclosure provides for a centralized intelligent holistic orchestrator-agnostic supervisor unit deployed as an independent process in a customer's training cluster. The supervisor unit is responsible for actively monitoring and controlling all accelerator nodes participating in training.

The system and method is generally described herein in relation to a cloud architecture including one or more containers running on a pod, and one or more pods running on a node, with each node being part of a cluster. Each node may be a virtual machine running an instance. However, it should be understood that the system and method may also be implemented on other types of cloud architectures.

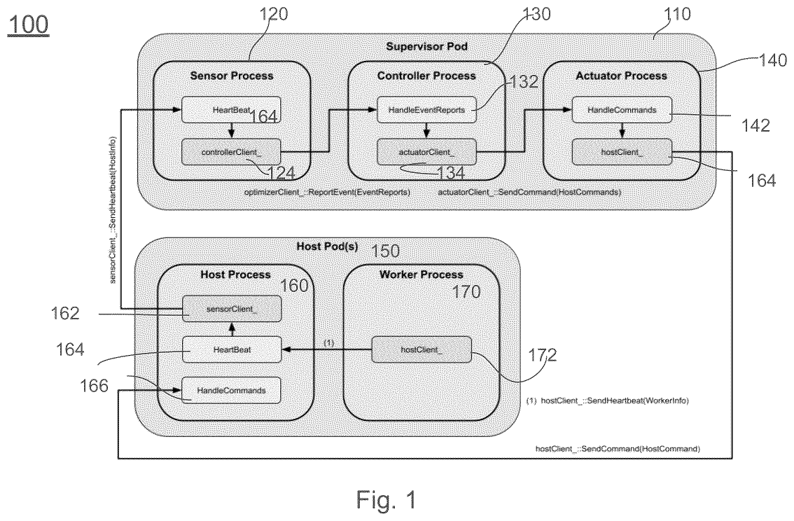

FIG. 1 illustrates an example architecture of a system 100 including centralized supervisor unit 110. The centralized supervisor unit 110 includes independent processes, including a sensor 120, a controller 130, and an actuator 140.

The sensor 120 is responsible for actively monitoring “heartbeat” signals 164 from all accelerator nodes participating in training. For example, as shown, host client 172 of worker process 170 sends heartbeat signal 164 to host process 160. Sensor 120 receives the heartbeat signal 164 from host process 160 of host pod 150 through sensor client interface 162 of the host process 160. Should a training process unexpectedly fail, the sensor 120 is programmed to detect this anomaly and report the incident to the controller 130, such as through controller client interface 124.

The sensor 120 is designed to be easily extensible. Should there be another source of signals indicative of the health of the cluster, the sensor 120 can be extended to also monitor said signals. An example of this would be out-of-band telemetry analysis which could indicate the presence of performance degradation or network stragglers. Extending the sensor 120 to ingest a broad range of networking and hardware telemetries would enable the supervisor 110 to detect performance degradation and stragglers, which are hard to identify without sufficient telemetries.

The controller 130 is responsible for receiving reports of anomalies in the training cluster from the sensor 120 and determining what the best course of action is to help mitigate the issue. The controller 130 has access to several options of how to react to a failure, and intelligently selects the best one to execute given the nature of the failure observed as well as the training parallelism configuration employed by the customer on their training cluster. For example, the controller 130 executes an event report handling method 132. After selecting and executing one of the options, the controller 130 will generate a set of commands, which when executed, will ensure the cluster arrives at a new stable training state. The commands may be provided to the actuator 140 through actuator client interface 134 of the controller 130. The supervisor 110 has the capability of addressing problematic hardware with accelerator granularity. For example, the supervisor 110 can address problematic hardware at the individual GPU level, and not just at the virtual machine level.

The actuator 140 is responsible for receiving commands from the controller 130 and routing them to the specific hosts or accelerator VM abstractions which need to execute them in order to remap the workload's training parallelism configuration successfully. For example, the commands are handled by command handler 142 of the actuator 140 and provided to command handler 166 of host process 160 through host client interface 164 of the actuator process 140. Command primitives that ultimately get executed by hosts may be referred to as “callbacks,” where a command relayed by the actuator may contain one or more callbacks to be executed in an atomic fashion. Some example callbacks include:
start: begin executing user training code in a GPU subprocess
stop: terminate the subprocess executing user training code
send_ckpt: send a checkpoint to a peer host process to be used to initialize a training process.
recv_ckpt: receive a checkpoint from a peer host process to be used to initialize a training process

Elastic strategies are policies which determine how training workload and the respective state should adjust when training capacity scales down or up. These elastic strategies are designed to be customizable, providing customers with optionality to design their own strategies specific to their workloads.

Upon detected failure or newly introduced hardware, an elastic optimizer determines the best strategy to apply to the workload based on a customizable heuristic and relay a set of callbacks to execute to the actuator 140. The elastic optimizer allows customers to support multiple elastic strategies and provides a mechanism to determine which strategy to use. To make decisions about training, elastic strategies and the elastic optimizer rely on a custom object, referred to as a mesh, that tracks mappings between the physical and virtual topology of the training cluster. The mesh enables the elastic strategies and optimizers to have locality information with individual device granularity when making remapping decisions. Objects related to elastic strategies live within the controller component 130 of the supervisor 110.

The family of elastic strategies for customers may provide policies for a GPU reset, hot swapping, and/or dynamic data replication. While these are a few examples of elastic strategies that are described herein, other strategies are possible. As a large percentage of unexpected interruptions may be due to GPU-related issues, a significant portion of these issues may be resolvable by resetting the GPU in question, which is supported by the resetting policy. Relying on designating a portion of training capacity as holdback may be supported in the hot swapping policy.

The dynamic data replication strategy (DDRS) supports dynamic adjustments to training state by adjusting the number of data replicas. Since each data replica contains a complete copy of the model weights, when an individual GPU or virtual machine goes down, the associated data replicas can be removed while leaving the previous replicas the same. Data loading and learning rates will need adjustments to accommodate the new number of training processes. The dynamic data replica strategy also assumes that a training workload is using data parallelism. Thus, unlike the previously mentioned strategies, dynamic data replica strategy enables training to be truly elastic, where the number of hardware accelerators used to train is adaptive to capacity availability. The dynamic data replica strategy is one of many creative strategies that can be applied based on what forms of model and training parallelisms customers are using on their workloads.

The mesh mentioned above may include both physical and virtual mappings of the training workload. The virtual and physical mappings are used to inform elastic strategy decision logic.

The physical mapping defines where devices should be placed in the virtual mapping. The physical mapping tracks all hosts and their respective GPUs, including labels for physical location and GPU/host status. The physical mappings track physical attributes of the GPUs and hosts. Tracking device states provides the supervisor 110 with an accurate and up-to-date understanding of how training capacity is used and the capacity's health.

The virtual mapping defines how devices interact with each other. The virtual mapping tracks host and GPU communication groups and how these devices map to distributed ranks. The virtual mapping of a training workload is defined by the various training parallelisms used in large scale distributed training. These training parallelisms can be abstracted to take the shape of a N-dimensional mesh, where the number of dimensions aligns with the number of parallelisms. If the mesh is placed on a N-dimensional grid, each GPU's location can be defined by its coordinates: (x₁, . . . , xₙ). This mesh, placed on a grid, can be used to track each GPU's place within its respective distributed groups, indicating device ranks and relative ordering to each other. One assumption about how ranks and coordinates map to each other to support elasticity using this definition of virtual maps is illustrated by the following equation:

$$rank ( {x}_{1} , … , {x}_{n} ) \geq rank ( {y}_{1} , … , {y}_{n} ) ⇔ \{ {x}_{i} \geq {y}_{i} \vert i = 1 , … , n \}$$

where rank: [symbol] → [symbol] is an arbitrary function that provides the rank of the device at the specified coordinates. This assumption provides for the updating of ranks upon scale up and scale down events.

The virtual mapping state is kept up-to-date as training capacity fluctuates and the training workload removes or takes on new GPUs.

The elastic strategies are training strategies that are adjustable in the face of capacity changes. When failures occur in the cluster, training either completely stops or will continue at a degraded rate. To resume training from a failed or degraded state, the training job excludes all faulty devices. For these scale down events, the elastic strategy removes culprit/faulty devices; updates rank and world size; updates distributed groups; synchronizes training state; adjusts data loaders; and adjusts learning rates.

There are also situations in training where capacity previously unavailable will later on be ready for use. Some examples include maintenance or repair events, where capacity will enter an unusable state for a temporary period of time. The elastic strategies also detect and react to scale-up events, in which they add idle healthy devices, if possible; update rank and world size; update distributed groups; synchronize training state; adjust data loaders; and adjust learning rates.

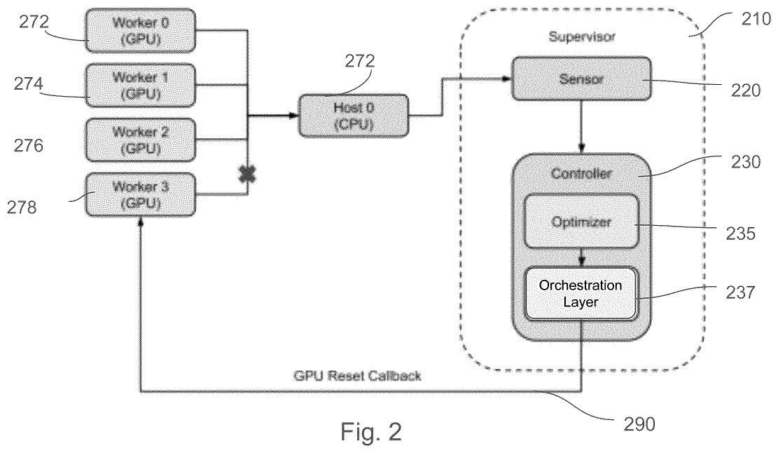

At runtime, the optimizer can determine which of the elastic strategies is best fit for the training workload. Customers may also create their own strategies that can be compared against pre-existing strategies at runtime. An elastic strategy interface is provided to allow users to customize their own adaptive policies and provide a set of pre-built strategies. The elastic strategy interface defines an extensible way to remap the distributed process groups housed within the mesh.
FIG. 2 illustrates an example of the GPU reset elastic strategy. A plurality of workers 272, 274, 276, 278, such as GPUs, provide heartbeat signals to a host central processing unit (CPU) 250. Upon detecting a GPU failure in worker 278 via a missing heartbeat from the worker 278, the host CPU 260 reports this to sensor 220 in supervisor 210. For example, the host CPU 260 may communicate with the sensor 220 via a heartbeat API. The sensor 220 then reports this to controller 230, which determines that a GPU reset is required via optimizer 235. This then invokes a GPU reset callback 290 from orchestration layer 237. An orchestrator interface can be implemented for different orchestrator types. The “callbacks” defined in the orchestrator interface define different orchestrator level commands that should be supported in order to provide critical, cluster level functionality to enable elastic training actuation. Responsibilities of the orchestrator interface may include triggering cluster-wide reset, hot-swapping new capacity, rebooting a host, rebooting a container, and resetting GPUs.

The supervisor 210 may keep track of metadata, such as host info, device state, etc., for every host that registers with it. The host info may include, for example, a host address, host identifier, host serial number, host name, subblock identifier, superblock identifier, zone, rank, etc.

The GPU reset callback may include several steps for increased compatibility with architectures. A first step may be to taint the pod to be reset with some custom taint to prevent it from being scheduled for training. A taint is a property that may be applied to a node or pod allowing it to repel other nodes or pods. Since this pod is online and participating in training, it would immediately be terminated since this custom taint would not be tolerated by the workload deployment. A state from the GPUs may have been persisted onto the host CPU 260 memory prior to the GPU reset callback.

A next step may be to disable the GPU device plugin. If this is not done, the GPU reset command is unsuccessful and reports that a reset cannot happen if something is running on the GPU.

After the device plugin has been disabled, a privileged pod may be created on the target physical host. The GPU reset command may be run on the host 260 machine directly.

After resetting the target GPU (worker 278), the GPU device plugin can be re-enabled and the reset pod may be un-tainted, allowing it to re-introduce itself into training on the same physical machine. Since the workload deployment has the highest priority class in the cluster, the node will be allocated back to the workload.

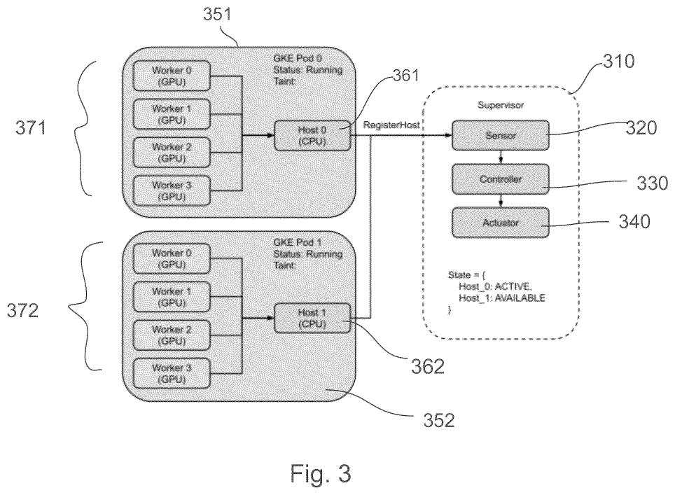

FIGS. 3-5 illustrate an example of the hot swapping elastic strategy. Virtual machine hot-swap refers to being able to quickly replace a faulty node with a healthy node not previously participating in training. In a given superblock, hot-swappable capacity may come either from cloud service managed holdback or from nodes being used for low-priority preemptable workloads. Nodes not currently being used for hero workload training should be available for preemptable workloads. All nodes outside of the cloud service managed holdback should be registered with the supervisor, regardless if they are being used for hero workload training or not.

FIG. 3 illustrates multiple pods 351, 352 managed by supervisor 310. Each pod 351, 352 includes a respective host CPU 361, 362 and a plurality of workers 371, 372, such as GPUs. While only two pods 351, 352 are illustrated, it should be understood that any number of pods may be managed by the supervisor 310. According to some examples, first pod 351 may be used for hero workloads, such as high priority workloads, while second pod 352 is used for low priority, preemptable workloads. Both pods 351, 352 register the respective hosts 361, 362 with the supervisor 310, which sets the first host 361 to an ACTIVE state, indicating that it will participate in hero training. The supervisor 310 may set the second host 362 to an AVAILABLE state, indicating that it is unused, but available if required. Registering all hosts 361, 362 not only gives the supervisor visibility over all capacity that could be used in the hero workload, but it also has the added benefit of pre-loading and caching the hero workload images onto these hosts.

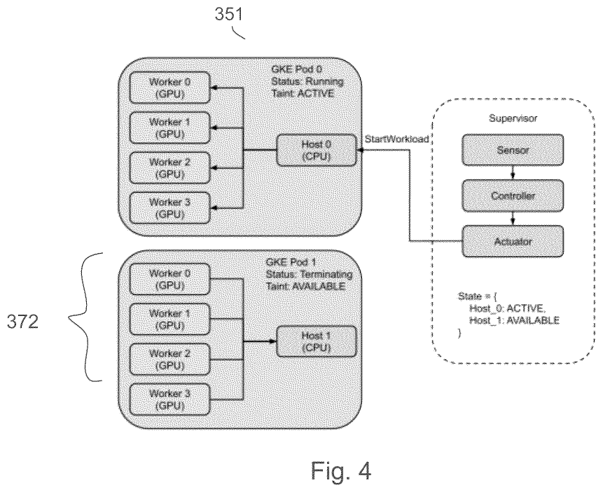

As shown in FIG. 4, the actuator 340 of the supervisor 310 sends back a command for the first pod 351 to start the hero workload. Additionally, using the training orchestration layer, each pod 351, 352 is tainted with their corresponding state.

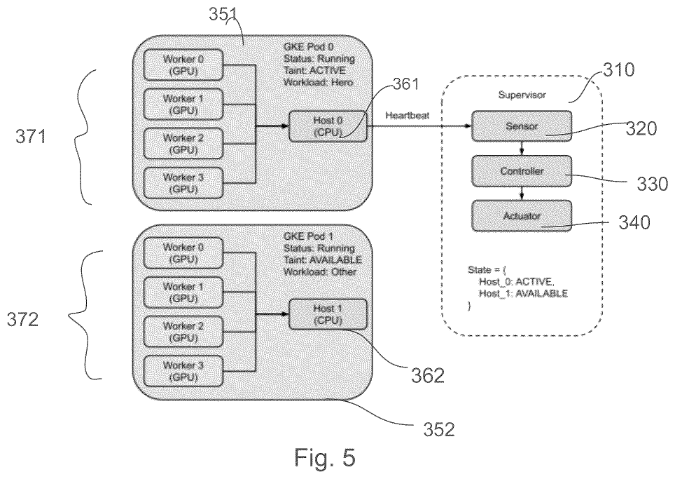

As shown in FIG. 5, the second pod 352 is terminated after the intolerated taint “AVAILABLE” is applied, freeing it for other low priority workloads. Low priority workloads should be configured to tolerate the “AVAILABLE” taint. The first pod 351, on the other hand, begins to run the hero workload and heartbeat state to the supervisor 310.

If any of the virtual machines participating in the hero workload experience a failure, it gets reported to the supervisor 310 over the heartbeating mechanism. At this point the supervisor 310 can iterate over its internal state representation to see if any hosts 361, 362 have an “AVAILABLE” status. Once a suitable “AVAILABLE” host is found, the supervisor 310 executes the following process, where node X denotes the node experiencing a failure, pod X denotes the training container running on node X, node Y denotes the node running a low-priority workload, and pod Y denotes the training container running on node Y. First, the supervisor 310 issues a command to stop training. Next, the supervisor 310 applies a “NoSchedule” taint to node Y, causing the low-priority workload pod to be preempted. The supervisor 310 clears all taints from node Y, causing it to be scheduled to the hero workload given its higher priority. The pod Y registers with the supervisor 310 and is tainted as “ACTIVE”. The supervisor 310 sends pod X a command to synchronize state with pod Y. The supervisor 310 applies “NoSchedule” taint to node X. The supervisor 310 issues a command to start training to all “ACTIVE” pods.

While cloud service managed holdback isn't visible to the customer cluster, accessing it from the supervisor may require explicitly requesting it via cloud service API. Using this API, the orchestrator interface can be extended to also include automatic outcasting of nodes that fail GPU resets, and automatic replacement of these nodes from managed holdback. The ability to dynamically introduce managed holdback adds one more level of complexity which should be analyzed to determine optimal behavior.

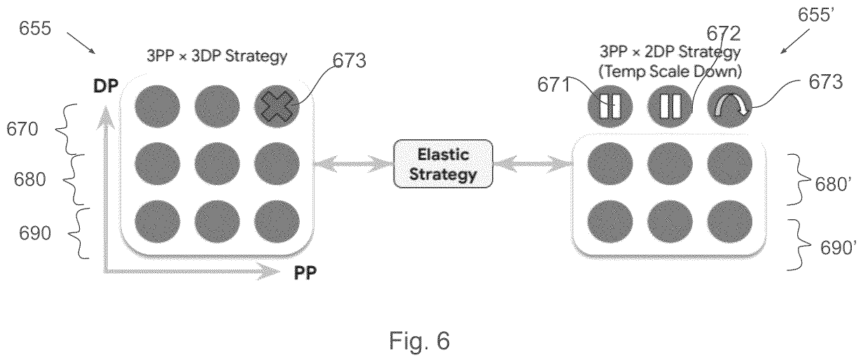

FIGS. 6-9 illustrate examples of dynamic data replica strategy (DDRS). DDRS refers to adjusting the number of data replicas based on signals detected by the supervisor, where groups are removed from training when training capacity scales down, such as due to failures, repairs, etc. Groups are added back when training capacity scales up, such as due to maintenance/repairs completing, etc. DDRS focuses on the data dimension, and can be used when the training strategy involves some form of data parallelism such that there are multiple data replicas.

Using the defined data replica groups, DDRS can track which data replicas are active in training and which are inactive. DDRS needs to know the number of available hosts and workers to correctly identify when a data replica can be added to training.

Upon deferred initialization, DDRS determines the coordinate->rank mapping such that when rank remappings are required due to scaling events, the strategy has sufficient information to correctly assign new ranks.

Whenever the sensor detects an unexpected change to the cluster, it will inform the controller via an event report signal. This event report signal contains information on the detected event, in particular the new states for certain objects. The elastic strategies ingest this event report signal to determine what response is appropriate. Example responses may include: (1) do nothing except for updating internal state, (2) scale down training, and (3) scale up training.

FIG. 6 illustrates an example of scaling down. FIG. 6 illustrates an initial array 655 of nodes for executing a machine learning model, wherein the initial array 655 implements data parallelism and pipeline parallelism. For example, the array 655 includes a plurality of replicas 670, 680, 690. By definition, each replica 670 680 690 contains a full set of model weights and ingests a unique stream of data to train on. Each replica communicates with other replicas to combine intermediate results. At a high level, DDRS tracks all data replicas 670, 680, 690 and the coordinates of these data replicas 670, 680, 690. When a device or set of devices needs to be removed, the DDRS determines which data replicas include the devices to be removed and removes these data replicas. For example, as shown, device 673 is identified as faulty and therefore needs to be removed. Because the replica 670 includes the faulty device 673, the entire replica 670, including devices 671, 672, 673, is removed from training and labeled as “inactive” by DDRS, resulting in updated array 655′. With the remaining “active” data replicas 680′, 690′ in the updated array 655′, DDRS can redefine device ranks and new global world size. When scaling down no state synchronization is needed. DDRS will instruct devices removed from training to call stop and devices that remain in training to call stop->start.

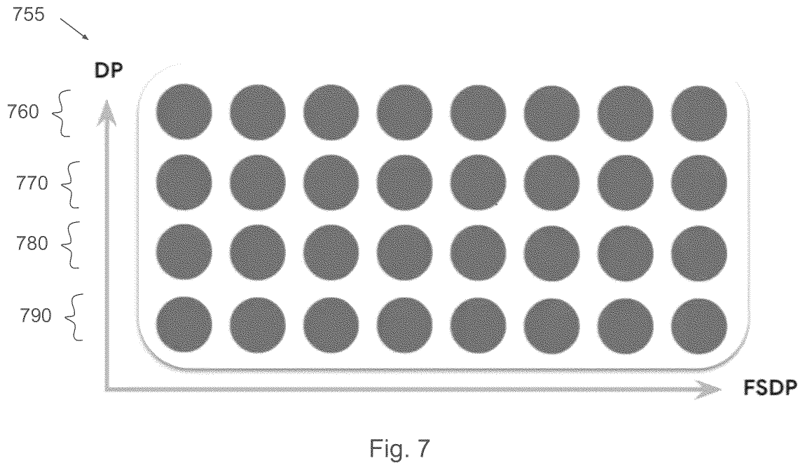

FIG. 7 illustrates another example array 755 of nodes for training and executing a machine learning model using data parallelism and fully sharded data parallelism. In this example, the workload applies hybrid-sharded data parallelism (HSDP) in which there are 4 data replicas 760, 770, 780, 790. Each replica 760, 770, 780, 790 includes a plurality of devices, wherein the devices stores its respective shard of the machine learning model.

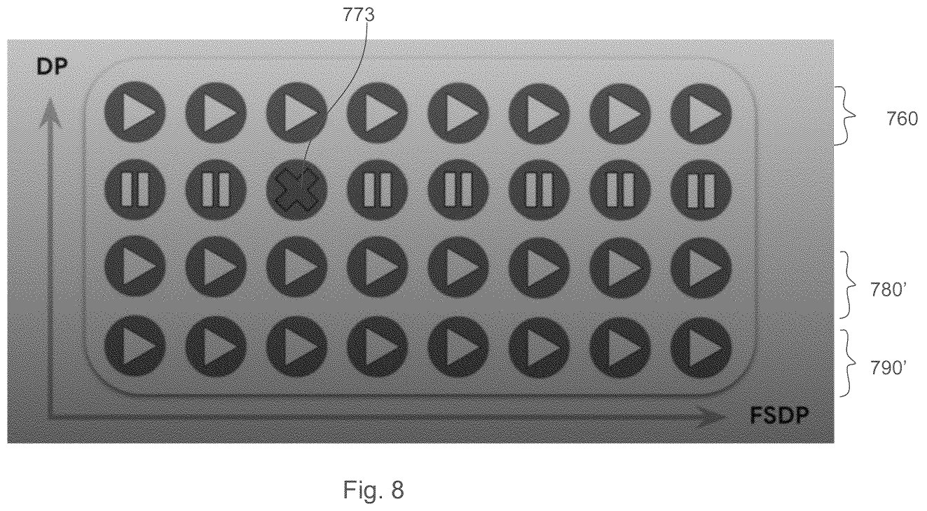

As shown in FIG. 8, one device 773 has a failure. Accordingly, the replica 770 including the failed device 773 is paused, while remaining replicas 760′, 780′, 790′ remain active.

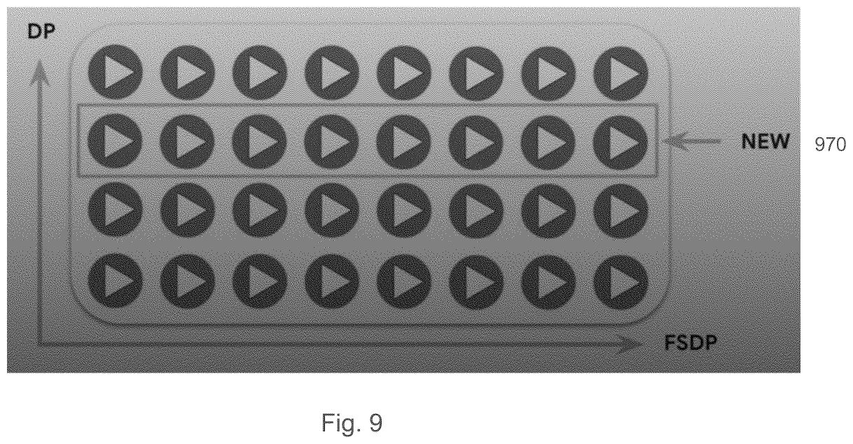

As shown in FIG. 9, a new replica 970 may be deployed in place of the replica 7 including failed device 773 of FIG. 8. The deployment of a new replica 970 may be referred to as scaling up. DDRS keeps track of the coordinates in each active and inactive data replica. When sufficient capacity is available, DDRS can add the capacity back into training and assign these devices coordinates from one of the inactive data replicas. With the new set of “active” data replicas, DDRS can redefine device ranks and new global world size. For each device in the newly added data replica(s), DDRS will determine a peer for synchronizing state. For devices in the newly introduced data replica, DDRS instructs them to recv_ckpt->start. For devices already used in training that have a peer they need to synchronize state with, DDRS instructs them to stop->send_ckpt->start. For all other devices active in training, DDRS instructs them to stop->no_op_ckpt->start.

The optimizer may be used to dynamically compare existing elastic strategies and select the optimal strategy to execute given the detected failure. The optimizer is designed as an extensible interface, supporting customizable logic for determining the optimal strategy.

The approach of implementing a supervisor pod that is a single intelligent holistic control is advantageous in that it provides an ability to select between a family of elastic strategies with the aim of optimizing training goodput. Defining the supervisor in terms of sensing, controlling, and actuation as a single entity meets the definition of a single holistic controller.

The abstraction of elastic strategies and the supervisor provide customers with a set of APIs and intercepts at the framework level to define their own strategies without needing to worry about orchestration logic. Customers have the optionality of using elasticity out-of-the-box but also can design their own workload-specific strategies as needed. The abstractions provide customers with infrastructure for selecting the best option out of a family of elastic strategies. Compared to other existing solutions that focus primarily on orchestration elasticity, these abstraction intercepts support elasticity at the orchestration and framework levels, thus providing the most support and customizations in regards to training elasticity.

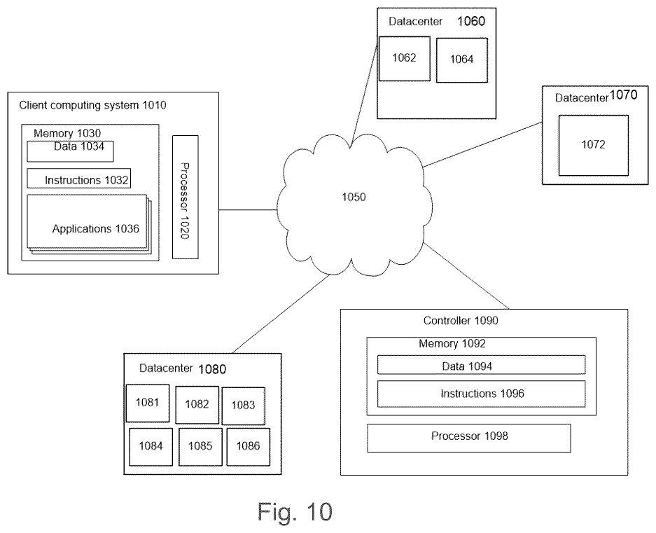

FIG. 10 illustrates an example system including a distributed computing environment. A plurality of datacenters 1060, 1070, 1080 may be communicatively coupled, for example, over a network 1050. The datacenters 1060, 1070, 1080 may further communicate with one or more client devices, such as client 1010, over the network 1050. Thus, for example, the client 1010 may execute operations in “the cloud.” In some examples, the datacenters 1060, 1070, 1080 may further communicate with a controller 1090.

The datacenters 1060-1080 may be positioned a considerable distance from one another. For example, the datacenters may be positioned in various countries around the world. Each datacenter 1060, 1070, 1080 may include one or more computing devices, such as processors, servers, shards, cells, or the like. For example, as shown in FIG. 10, datacenter 1060 includes computing devices 1062, 1064, datacenter 1070 includes computing device 1072, and datacenter 1080 includes computing devices 1081-1086. Programs may be executed across these computing devices, for example, such that some operations are executed by one or more computing devices of a first datacenter while other operations are performed by one or more computing devices of a second datacenter. In some examples, the computing devices in the various datacenters may have different capacities. For example, the different computing devices may have different processing speeds, workloads, etc. While only a few of these computing devices are shown, it should be understood that each datacenter 1060, 1070, 1080 may include any number of computing devices, and that the number of computing devices in a first datacenter may differ from a number of computing devices in a second datacenter. Moreover, it should be understood that the number of computing devices in each datacenter 1060-1080 may vary over time, for example, as hardware is removed, replaced, upgraded, or expanded.

In some examples, each datacenter 1060-1080 may also include a number of storage devices (not shown), such as hard drives, random access memory, disks, disk arrays, tape drives, or any other types of storage devices. The datacenters 1062, 1072, 1082 may implement any of a number of architectures and technologies, including, but not limited to, direct attached storage (DAS), network attached storage (NAS), storage area networks (SANs), fibre channel (FC), fibre channel over Ethernet (FCoE), mixed architecture networks, or the like. The datacenters may include a number of other devices in addition to the storage devices, such as cabling, routers, etc. Further, in some examples the datacenters 1060-1080 may be virtualized environments. Further, while only a few datacenters 1060-1080 are shown, numerous datacenters may be coupled over the network 1050 and/or additional networks.

In some examples, the controller 1090 may communicate with the computing devices in the datacenters 1060-1080, and may facilitate the execution of programs. For example, the controller 190 may track the capacity, status, workload, or other information of each computing device, and use such information to assign tasks. The controller 1090 may include a processor 1098 and memory 1092, including data 1094 and instructions 1096, similar to the client 1010 described above. In other examples, such operations may be performed by one or more of the computing devices in one of the datacenters 1060-1080, and an independent controller may be omitted from the system.

Each client 1010 may be, for example, a computer intended for use by a person or an entity. The client 1010 may have all the internal components normally found in a personal computer such as a central processing unit (CPU), CD-ROM, hard drive, and a display device, for example, a monitor having a screen, a projector, a touch-screen, a small LCD screen, a television, or another device such as an electrical device that can be operable to display information processed by processor 1020, speakers, a modem and/or network interface device, user input, such as a mouse, keyboard, touch screen or microphone, and all of the components used for connecting these elements to one another. Moreover, computers in accordance with the systems and methods described herein may include devices capable of processing instructions and transmitting data to and from humans and other computers including general purpose computers, PDAs, tablets, mobile phones, smartwatches, network computers lacking local storage capability, set top boxes for televisions, and other networked devices.

The client 1010 may contain a processor 1020, memory 1030, and other components typically present in general purpose computers. The memory 1030 can store information accessible by the processor 1020, including instructions 1032 that can be executed by the processor 1020. Memory can also include data 1034 that can be retrieved, manipulated or stored by the processor 1020. The memory 1030 may be a type of non-transitory computer readable medium capable of storing information accessible by the processor 1020, such as a hard-drive, solid state drive, tape drive, optical storage, memory card, ROM, RAM, DVD, CD-ROM, write-capable, and read-only memories. The processor 1020 can be a well-known processor or other lesser-known types of processors. Alternatively, the processor 1020 can be a dedicated controller such as an ASIC.

The instructions 1032 can be a set of instructions executed directly, such as machine code, or indirectly, such as scripts, by the processor 1020. In this regard, the terms “instructions,” “steps” and “programs” can be used interchangeably herein. The instructions 1032 can be stored in object code format for direct processing by the processor 1020, or other types of computer language including scripts or collections of independent source code modules that are interpreted on demand or compiled in advance.

The data 1034 can be retrieved, stored or modified by the processor 1020 in accordance with the instructions 1032. For instance, although the system and method is not limited by a particular data structure, the data 1034 can be stored in computer registers, in a relational database as a table having a plurality of different fields and records, or XML documents. The data 1034 can also be formatted in a computer-readable format such as, but not limited to, binary values, ASCII or Unicode. Moreover, the data 1034 can include information sufficient to identify relevant information, such as numbers, descriptive text, proprietary codes, pointers, references to data stored in other memories, including other network locations, or information that is used by a function to calculate relevant data.

Applications 1036 may be used for any of a variety of operations. The applications 1036 may, for example, be downloaded, executable from the instructions 1032, or remotely accessed. In some examples, the application may be remotely executed. For example, applications on the client device may be executed in the cloud.

Although FIG. 10 functionally illustrates the processor 1020 and memory 1030 as being within the same block, the processor 1020 and memory 130 may actually include multiple processors and memories that may or may not be stored within the same physical housing. For example, some of the instructions 1032 and data 1034 can be stored on a removable CD-ROM and others within a read-only computer chip. Some or all of the instructions and data can be stored in a location physically remote from, yet still accessible by, the processor 1020. Similarly, the processor 1020 can actually include a collection of processors, which may or may not operate in parallel.

Client 1010, datacenters 1060-1080, and control 1090 can be capable of direct and indirect communication such as over network 1050. For example, using an Internet socket, a client 1010 can connect to a service operating on remote servers through an Internet protocol suite. Servers can set up listening sockets that may accept an initiating connection for sending and receiving information. The network 1050, and intervening nodes, may include various configurations and protocols including the Internet, World Wide Web, intranets, virtual private networks, wide area networks, local networks, private networks using communication protocols proprietary to one or more companies, Ethernet, WiFi (e.g., 702.71, 702.71b, g, n, or other such standards), and HTTP, and various combinations of the foregoing. Such communication may be facilitated by a device capable of transmitting data to and from other computers, such as modems (e.g., dial-up, cable or fiber optic) and wireless interfaces.

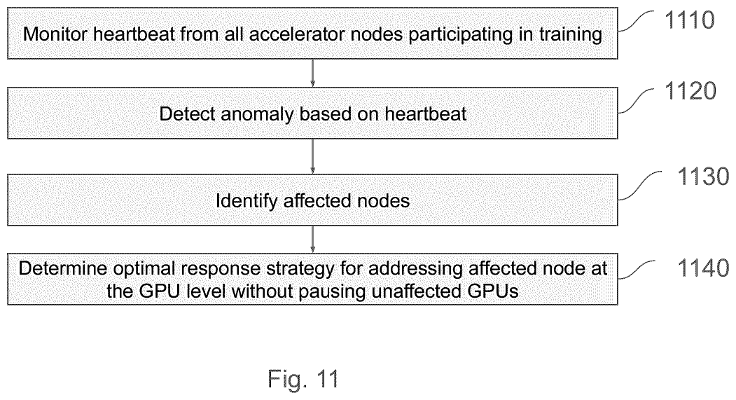

FIG. 11 illustrates an example method 1100 for utilizing elastic strategies to optimize training goodput. The method may be executed at, for example, a supervisor node in communication with one or more host processes. It should be understood that the following operations do not have to be performed in the precise order described below. Rather, various operations may be handled in a different order or simultaneously. Operations may also be added or omitted unless otherwise stated.

In block 1110, supervisor monitors heartbeat signals from all accelerator nodes participating in training. For example, a sensor process of the supervisor receives heartbeat signals from each host, which receives the heartbeat signals from each worker or GPU.

In block 1120, the supervisor detects an anomaly based on the heartbeat. For example, the sensor process may detect that it stops receiving heartbeat signals from a particular worker, or that the heartbeat signals from a particular worker are delayed or otherwise anomalous.

In block 1130, the supervisor identifies the affected nodes. For example, the affected nodes may be any nodes that include the worker sending anomalous heartbeat signals.

In block 1140, the supervisor determines an optimal response strategy for addressing the affected nodes at the worker/GPU level, without pausing unaffected workers/GPUs. For example, the supervisor may determine which elastic strategy to implement through the optimizer, which includes customizable logic for how to select between multiple strategies. Example strategies can include GPU reset, hot swapping, and DDRS, as discussed above.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for optimizing training goodput, the method comprising:
monitoring, by a supervisor node, heartbeat signals from all processing units participating in training;
detecting, by the supervisor node, an anomaly based on the heartbeat signals;
identifying, by the supervisor node, affected processing units affected by the anomaly; and
determining, by the supervisor node, a response strategy for addressing the affected processing units at a worker level without pausing unaffected processing units.

2. The method of claim 1, wherein the response strategy comprises one of a processing unit reset, hot swapping of the affected processing units, or a dynamic data replication strategy.

3. The method of claim 2, wherein the processing unit reset comprises issuing a callback from an optimization layer of a controller process executed by the supervisor node.

4. The method of claim 3, wherein processing unit reset comprises:
tainting a pod containing the affected processing units to prevent the pod from being scheduled for training;
disabling any plugins of the affected processing units;
creating a privileged pod on a target physical host;
running a reset command for the affected processing units on the target physical host;
re-enabling the plugins of the affected processing units; and
untainting the pod, allowing it to be reintroduced into training.

5. The method of claim 2, wherein hot swapping of the affected processing units comprises:
registering all available hosts to the supervisor node;
updating a status of each of the registered hosts; and
preempting low priority workloads.

6. The method of claim 5, wherein hot swapping the affected processing units comprises swapping in a processing unit from cloud service managed holdback.

7. The method of claim 2, wherein dynamic data replication strategy comprises generating a physical mapping tracking all hosts and their respective processing units, and generating a virtual mapping tracking host and workload communication groups.

8. The method of claim 2, wherein dynamic data replication strategy comprises removing data replicas in response to a reduction in training capacity.

9. The method of claim 2, wherein dynamic data replication strategy comprises adding groups of data replicas in response to an increase in training capacity.

10. The method of claim 1, wherein detecting the anomaly comprises detecting a missing heartbeat.

11. A system for optimizing training, comprising:
a supervisor executing a plurality of independent processes, the independent processes including a sensor process, a controller process, and an actuator process, wherein the supervisor is configured to:
monitor heartbeat signals from all processing units participating in training;
detect an anomaly based on the heartbeat signals;
identify affected processing units affected by the anomaly; and
determine a response strategy for addressing the affected processing units at a worker level without pausing unaffected processing units.

12. The system of claim 11, wherein the response strategy comprises one of a processing unit reset, hot swapping of the affected processing units, or a dynamic data replication strategy.

13. The system of claim 12, wherein the processing unit reset comprises issuing a callback from an optimization layer of a controller process executed by the supervisor.

14. The system of claim 13, wherein processing unit reset comprises:
tainting a pod containing the affected processing units to prevent the pod from being scheduled for training;
disabling any plugins of the affected processing units;
creating a privileged pod on a target physical host;
running a reset command for the affected processing units on the target physical host;
re-enabling the plugins of the affected processing units; and
untainting the pod, allowing it to be reintroduced into training.

15. The system of claim 12, wherein hot swapping of the affected processing units comprises:
registering all available hosts to the supervisor;
updating a status of each of the registered hosts; and
preempting low priority workloads.

16. The system of claim 15, wherein hot swapping the affected processing units comprises swapping in a processing unit from cloud service managed holdback.

17. The system of claim 12, wherein dynamic data replication strategy comprises generating a physical mapping tracking all hosts and their respective processing units, and generating a virtual mapping tracking host and workload communication groups.

18. The system of claim 12, wherein dynamic data replication strategy comprises removing groups of data replicas in response to a reduction in training capacity.

19. The system of claim 12, wherein dynamic data replication strategy comprises adding groups of data replicas in response to an increase in training capacity.

20. The system of claim 11, wherein detecting the anomaly comprises detecting a missing heartbeat.
